(19) United States
(12) Patent Application Publication
(10) Pub. No.: US 2016/0274018 A1
(43) Pub. Date: Sep. 22, 2016

(54) GAS PERMEABILITY MEASUREMENT APPARATUS AND GAS PERMEABILITY MEASUREMENT METHOD

(71) Applicant: Korea Research Institute of Standards and Science, Daejeon (KR)

(72) Inventors: Dae-Jin Seong, Chungcheongnam-do (KR); Yong-Hyeon Shin, Daejeon (KR); In-Tae Lim, Daejeon (KR)

(21) Appl. No.: 15/169,067

(22) Filed: May 31, 2016

Related U.S. Application Data
(63) Continuation of application No. PCT/KR2014/011111, filed on Nov. 19, 2014.

(30) Foreign Application Priority Data
Dec. 2, 2013 (KR) 10-2013-0148357

(51) Int. Cl. G01N 15/08

(52) U.S. Cl. CPC G01N 15/08

(57) ABSTRACT

A gas permeability measurement apparatus and a gas permeability measurement method, including a first chamber filled with a measurement gas and maintained at a constant pressure, a second chamber connected in series to the first chamber, a third chamber connected in series to the second chamber, and a separating plate having a through-hole and separating the second chamber and the third chamber from each other. A conductance adjusting part is disposed between the second and third chambers to adjust conductance passing through the through-hole of the separating plate. A vacuum pump is connected to the third chamber to exhaust the third chamber. A differential pressure gauge measures differential pressure between the second and third chambers. A sample is disposed between the first and second chambers. The measurement gas is delivered to the second chamber after permeating the sample, and the conductance adjusting part sequentially provides at least two different conductances.

### CROSS-REFERENCE TO RELATED APPLICATIONS

This application is a continuation of and claims priority to PCT/KR2014/011111 filed on Nov. 19, 2014, which claims priority to Korea Patent Application No. 10-2013-0148357 filed on Dec. 2, 2013, the entireties of which are both incorporated by reference herein.

### TECHNICAL FIELD

The present disclosure relates to gas permeability measurement apparatuses and, more particularly, to a gas permeability measurement apparatus that reduces an error caused by parasitic conductance.

### BACKGROUND

A differential pressure method is one of gas permeability measurement methods. According to the differential pressure method, a gas permeability is determined by measuring an increasing rate of a pressure at a vacuum side by a permeated gas and a differential pressure between opposite ends of an orifice (through-hole) with a known conductance when a gas is introduced to one side of a sample and an opposite side of the sample is maintained in a vacuum state.

However, the differential pressure method has a limitation in accurately measuring gas permeability due to a parasitic conductance of a vacuum side.

### SUMMARY

Example embodiments of the present disclosure provide precise gas permeability measurement methods.

A gas permeability measurement apparatus according to an example embodiment of the present invention includes: a first chamber filled with a measurement gas and maintained at a constant pressure; a second chamber connected in series to the first chamber; a third chamber connected in series to the second chamber; a separating plate having a through-hole and separating the second chamber and the third chamber from each other; a conductance adjusting part disposed at a connection portion between the second chamber and the third chamber to adjust a conductance passing through the through-hole of the separating plate; a vacuum pump connected to the third chamber to exhaust the third chamber; and a differential pressure gauge measuring a differential pressure between the second chamber and the third chamber. A sample may be disposed at a connection portion between the first chamber and the second chamber, the measurement gas may be delivered to the second chamber after permeating the sample, and the conductance adjusting part may sequentially provide at least two different conductances.

In an example embodiment, the gas permeability measurement apparatus may further include: a pressure gauge connected to the first chamber; an auxiliary vacuum pump connected to the first chamber; a first valve disposed between the first chamber and the auxiliary vacuum pump to exhaust the first chamber; a gas container storing the measurement gas; and a second valve disposed between the gas container and the first chamber to deliver the measurement gas stored in the gas container to the first chamber.

In an example embodiment, the conductance adjusting part may include: a rotation plate with orifices having different radiuses disposed on a circumference having a constant radius from a central axis; a rotation shaft fixing the rotation plate to the separating plate and providing a rotational motion of the rotation plate; an auxiliary rotation plate combined with sawteeth formed on an outer edge surface of the rotation plate to provide rotational force; and an auxiliary rotation shaft providing the rotational force to the auxiliary rotation plate. The auxiliary rotation shaft may rotate while being fixed to the second chamber.

A gas permeability measurement apparatus according to another example embodiment of the present disclosure includes: a first chamber filled with a measurement gas and maintained at a constant pressure; a second chamber connected in series to the first chamber; a third chamber connected in series to the second chamber; a separating plate having a through-hole and separating the second chamber and the third chamber from each other; a conductance adjusting part disposed at a connection portion between the second chamber and the third chamber to adjust a conductance passing through the through-hole of the separating plate; a vacuum pump connected to the third chamber to exhaust the third chamber; a top pressure gauge measuring a pressure of the second chamber; a bottom pressure gauge measuring a pressure a pressure of the third chamber; and a processing part calculating a gas permeability of a sample using a measurement signal of the top pressure gauge and a measurement signal of the bottom pressure gauge. The sample may be disposed at a connection portion between the first chamber and the second chamber, the measurement gas may be delivered to the second chamber after permeating the sample, and the conductance adjusting part may provide at least two different conductances.

A gas permeability measurement method according to an example embodiment of the present disclosure includes: loading a sample between a first chamber and a second chamber connected in series to each other; exhausting the first chamber, the second chamber, and a third chamber; filling the first chamber with a measurement gas to be maintained at a fixed pressure; delivering the measurement gas filling the first chamber to the second chamber after permeating the sample; delivering the measurement gas delivered to the second chamber to the third chamber through a first orifice having a first conductance between the second chamber and the third chamber; measuring a first differential pressure, generated by the first orifice, between the second chamber and the third chamber; delivering the measurement gas delivered to the second chamber to the third chamber through a second orifice having a second conductance between the second chamber and the third chamber; measuring a second differential pressure, generated by the second orifice, between the second chamber and the third chamber; and calculating a gas permeability of the sample using the first differential pressure, the second differential pressure, the first conductance, and the second conductance.

### BRIEF DESCRIPTION OF THE DRAWINGS

The present disclosure will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present disclosure.

FIG. 1 illustrates a gas permeability measurement apparatus according to an example embodiment of the present disclosure.

FIG. 2 is an exploded perspective view of a conductance adjusting part in FIG. 1.

FIG. 3 illustrates a gas permeability measurement apparatus according to a modified embodiment of the present disclosure.

### DETAILED DESCRIPTION

Example embodiments will now be described more fully with reference to the accompanying drawings, in which some example embodiments are shown.

Example embodiments may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

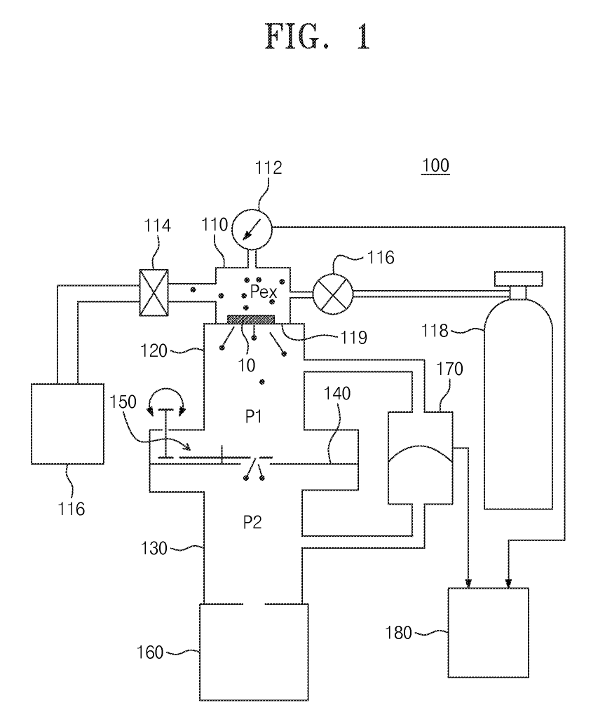

FIG. 1 illustrates a gas permeability measurement apparatus according to an example embodiment of the present disclosure.

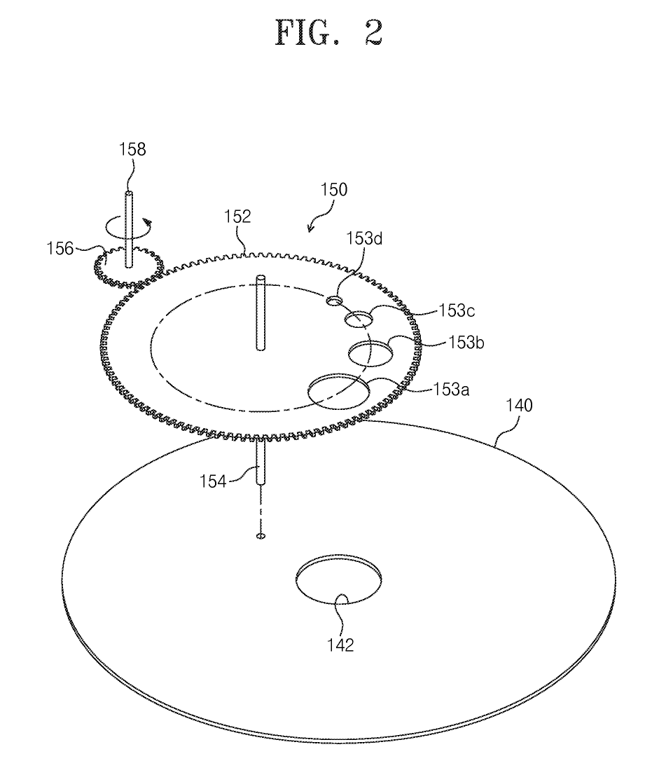

FIG. 2 is an exploded perspective view of a conductance adjusting part in FIG. 1.

Referring to FIGS. 1 and 2, a gas permeability measurement apparatus 100 includes a first chamber 110 filled with a measurement gas and maintained at a constant pressure, a second chamber 120 connected in series to the first chamber 110, a third chamber 130 connected in series to the second chamber 120, a separating plate 140 having a through-hole 142 and separating the second chamber 120 and the third chamber from each other 130, a conductance adjusting part 150 disposed at a connection portion between the second chamber 120 and the third chamber 130 to adjust a conductance passing through the through-hole 142 of the separating plate 142, a vacuum pump 160 connected to the third chamber 130 to exhaust the third chamber 130, and a differential pressure gauge 170 measuring a differential pressure between the second chamber 120 and the third chamber 130. A sample 10 is disposed at a connection portion between the first chamber 110 and the second chamber 120, the measurement gas is delivered to the second chamber 120 after permeating the sample 10, and the conductance adjusting part 150 sequentially provides at least two different conductances.

A gas permeability K of the sample 10 is defined, as below:

$$\begin{matrix}Q = K \cdot \frac{A}{L} \cdot ( {P}_{ex}^{1 / 2} - {P}_{1}^{1 / n} ) \\ = C \cdot ( {P}_{1} - {P}_{2} )\end{matrix} \qquad Equation ( 1 )$$

where Q represents a flow rate of a gas permeated per unit time, A represents an area of the sample 10, K represents a gas permeability of the sample 10, L represents a thickness of the sample 10, C represents a conductance of an orifice, Pex represents a pressure at the outside of the sample 10, P1 represents a pressure at an upper portion of an orifice, P2 represents a pressure at a lower portion of the orifice, and n represents a dissociation rate of gas molecules. In case of a non-metal, n=1. In case of metal permeation of hydrogen, n=2.

The Pex may be set to an atmospheric pressure, and the P1 may be set to a low voltage. Thus, Pex−P1 may approximate Pex.

A gas permeating the sample 10 may be provided to the second chamber 120, and a gas of the second chamber 120 may be exhausted to the third chamber 130 after passing through an orifice with a predetermined conductance. In this case, the flow rate Q may be given, as below:

Q=C·ΔP Equation (2)

where C represents a conductance of the orifice, and ΔP=P1−P2.

The gas permeability of the sample 10 may be measured using the Equations (1) and (2).

Conventionally, when a pressure Pex applied to the outside of a sample is 1 atmosphere, a gas permeability is calculated by measuring a differential voltage between opposite ends of an orifice. In this case, a conductance of the orifice is accurately defined but, in actual application, an effective conductance may be affected by various multiplicative factors. Thus, accuracy of the gas permeability is reduced.

According to an example embodiment, if the same flow rate Q is measured while varying a diameter or a conductance of the orifice, the gas permeability may be measured accurately.

When conductances of orifices are C1 and C1 respectively, use of two orifices having different conductances may allow an unknown same flow rate to be determined.

Q=(C₁+c)·ΔP₁ Equation (3)

In the Equation (3), c represents a parasitic capacitance associated with a measurement system and C1 represents a first conductance of a first orifice. The first conductance is determined by a geometrical structure. In addition, ΔP1 represents a pressure difference between opposite sides of the first orifice. The C1 and ΔP1 are accurate values. Specifically, the C1 is a mathematically defined and calculated value and the ΔP1 is a measured pressure difference between opposite sides of the first orifice.

When a second orifice having a conductance C2 determined by a geometrical structure is used, the unknown same flow rate Q may be given, as below:

Q=(C₂+c)·ΔP₂ Equation (4)

where C2 represents the conductance of the second orifice, c represents a parasitic capacitance associated with the measurement system, and ΔP2 represents a pressure difference between opposite sides of the second orifice.

A gas permeability desired to be obtained may be given using the Equations (3) and (4), as below:

$$Q = \frac{( {C}_{1} - {C}_{2} ) \cdot Δ {P}_{1} \cdot Δ {P}_{2}}{Δ {P}_{2} - Δ {P}_{1}} \qquad Equation ( 5 )$$

Accordingly, an accurate flow rate Q may be calculated. As a result, the gas permeability K may be calculated using the Equation (1).

The first chamber 110 may have a cylindrical structure. The first chamber 110 may be made of a metal. A pressure gauge 112 may measure a pressure of the first chamber 110. A first valve 114 may be disposed between the first chamber 110 and an auxiliary vacuum pump 116. When the first valve 114 is opened, the auxiliary vacuum pump 116 may exhaust the first chamber 110 to ultra-high vacuum. The first valve 114 may be closed while the first chamber 110 is exhausted to the ultra-high vacuum.

A gas container 118 may store the measurement gas. The measurement gas may be a nitrogen gas or an argon gas. The second valve 116 may be disposed between the gas container 118 and the first chamber 110 to deliver the measurement gas stored in the gas container 118 to the first chamber 110. While the first chamber 110 is maintained at an ultra-high vacuum state, the second valve 116 may be opened to fill the first chamber 110 with the measurement gas. Thus, the first chamber 110 may be filled with the measurement gas. When the first valve 114 and the second valve 116 are closed, the first chamber 110 may be maintained at a constant pressure (e.g., atmospheric pressure).

A sample support 119 may be disposed at a connection portion between the first chamber 110 and the second chamber 120. The sample support 119 may spatially separate the first chamber 110 from the second chamber 120 and may load the sample 10 thereon. The sample 10 may be a metal plate, a film or a dielectric material. The sample 10 may be fixed to the sample support 119 to be sealed. Thus, the measurement gas may be transferred to the second chamber 120 after permeating only the sample 10.

The first chamber 110 may be maintained at an atmospheric pressure or a high pressure of Torr unit, and the second chamber 120 may be maintained at about 10⁻⁶ Torr.

The second chamber 120 may be in the form of a cylinder. The second chamber 120 may be made of a metal material. A diameter of an upper portion of the second chamber 120 may be greater than a diameter of the first chamber 110. A diameter of a lower portion of the second chamber 120 may be greater than a diameter of an upper portion of the second chamber 120.

The third chamber 130 may be in the form of a cylinder. The third chamber 130 may be made of a metal material. A diameter of an upper portion of the third chamber 130 may be equal to a diameter of a lower portion of the second chamber. A diameter of a lower portion of the third chamber 130 may be smaller than a diameter of an upper portion of the third chamber 130.

The separating plate 140 may be disposed at a connection portion between the second chamber 120 and the third chamber 130. The separating plate 140 may spatially separate the second chamber 120 from the third chamber. The separating plate 140 may have a through-hole 140 formed in its center. By diffusion, the measurement gas may be delivered from the second chamber 120 to the third chamber 130 via the through-hole 142.

The conductance adjusting part 150 may be disposed at a lower portion of the second chamber 120. The conductance adjusting part 150 may partially close the through-hole 142 to adjust a conductance. More specifically, the conductance adjusting part 150 may include a rotation plate 152 with orifices 153a to 153d having different radiuses disposed on a circumference having a constant radius from a central axis, a rotation shaft 154 fixing the rotation plate 152 to the separating plate 140 and providing a rotational motion of the rotation plate 152, an auxiliary rotation plate 156 combined with sawteeth formed on an outer edge surface of the rotation plate 152 to provide rotational force, and an auxiliary rotation shaft 154 providing the rotational force to the auxiliary rotation plate 156. The auxiliary rotation shaft 158 may rotate while being fixed to the second chamber 120.

The rotation plate 152 may be in the form of a disc. The rotation plate 152 may include a plurality of orifices 153a to 153d. The orifices 153a to 153d may be aligned with the through-hole 142 of the separating plate 140. Thus, a conductance between the second chamber 120 and the third chamber 130 may be adjusted.

Each of the orifices 153a to 153d may be in the form of a circle. In the center of the rotation plate 152, the orifices 153a to 153d may be arranged at regular intervals on the circumference having a constant diameter.

The rotation shaft 154 may be connected to the central axis of the rotation plate 152. The rotation shaft 154 may be fixed to the separating plate 140. The rotation plate 152 may rotate on the rotation shaft 154. Thus, the conductance may vary depending on a diameter of an aligned orifice.

The auxiliary rotation plate 156 may be in the form of a disc. The auxiliary rotation plate 156 may provide a rotational motion to the rotation plate 152. A placement plane of the auxiliary rotation plate 156 may be identical to that of the rotation plate 152. Sawteeth may be formed on an outer edge surface of the auxiliary rotation plate 156. As the auxiliary rotation plate 156 rotates, the rotation plate 152 may rotate through gear engagement.

The auxiliary rotation shaft 154 may be disposed on the central axis of the auxiliary rotation plate 156. The auxiliary rotation plate 158 may be connected to the central axis of the auxiliary rotation plate 156. The auxiliary rotation shaft 158 may protrude to the outside of the second chamber 120. As the auxiliary rotation shaft 158 rotates, the rotation plate 152 may rotate.

According to a modified embodiment, the conductance adjusting part 150 may be disposed at an upper end portion of the third chamber 130.

According to a modified embodiment, means for adjusting a conductance between the second chamber 120 and the third chamber 130 may be transformed in the form of a camera aperture.

A lower end portion of the third chamber 130 may be connected to the vacuum pump 160. The vacuum pump 160 may exhaust the second chamber 130 and the second chamber 120 to ultra-high vacuum.

The differential pressure gauge 170 may measure a differential pressure between the second chamber 120 and the third chamber 130.

An external pressure of the pressure gauge 112 and a differential pressure signal of the differential pressure gauge 170 may be provided to a processing part 180. The processing part 180 may process the external pressure and the differential signal depending on a conductance to calculate a gas permeability of the sample 10.

A gas permeability method according to an example embodiment of the present disclosure will now be described below.

The sample 10 is loaded on the sample support 119. The sample support 119 is disposed between the first chamber 110 and the second chamber 120 that are connected in series to each other. The first chamber 110, the second chamber 120, and the third chamber 130 are exhausted while the first valve 114 is opened and the second valve 116 is closed. When pressures of the first chamber 110, the second chamber 120, and the third chamber 130 reach ultra-high pressure, the first valve 114 may be closed. Then, the second valve 116 may be opened and the measurement gas may be provided to the first chamber 110. When the pressure of the first chamber 110 reaches a predetermined pressure, the second valve 116 may be closed.

The measurement gas may be provided to the second chamber 120 after permeating the sample 10. The conductance adjusting part 150 may provide a first orifice of a first conductance. A first differential pressure between the second chamber 120 and the third chamber 130 may be measured while the first orifice is mounted.

Then, the conductance adjusting part 150 may provide a second orifice of a second conductance. A second differential pressure between the second chamber 120 and the third chamber may be measured while the second orifice is mounted.

The processing part 180 may calculate the gas permeability of the sample 10 using the first differential pressure, the second differential pressure, the first conductance, and the second conductance.

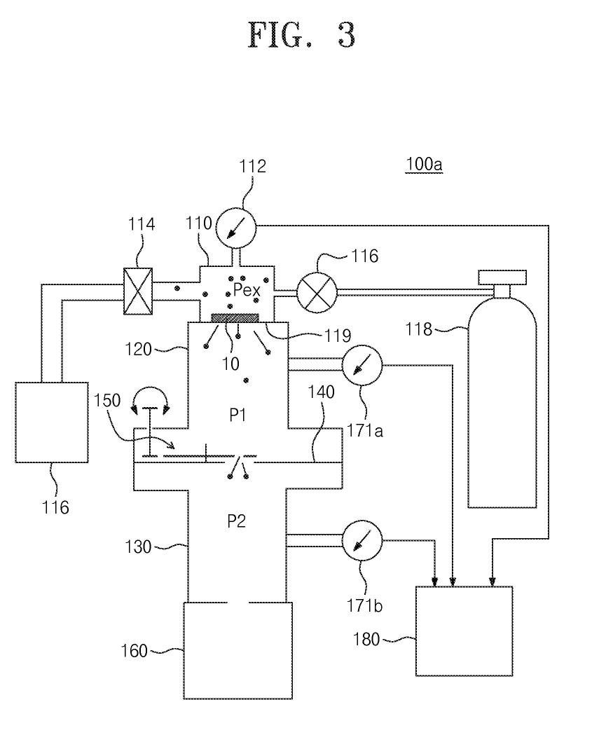

FIG. 3 illustrates a gas permeability measurement apparatus according to a modified embodiment of the present disclosure. In FIG. 3, the same components or parts as those shown in FIG. 1 are designated with the same numerals and their explanations will be omitted.

Referring to FIG. 3, a gas permeation measurement apparatus 100a includes a first chamber 110 filled with a measurement gas and maintained at a constant pressure, a second chamber 120 connected in series to the first chamber 110, a third chamber 130 connected in series to the second chamber 120, a separating plate 140 having a through-hole 142 and separating the second chamber 120 and the third chamber from each other 130, a conductance adjusting part 150 disposed at a connection portion between the second chamber 120 and the third chamber 130 to adjust a conductance passing through the through-hole 142 of the separating plate 142, a vacuum pump 160 connected to the third chamber 130 to exhaust the third chamber 130, a top pressure gauge 171a measuring a pressure of the second chamber 120, a bottom pressure gauge 171b measuring a pressure a pressure of the third chamber 130, and a processing part 180 calculating a gas permeability of a sample 10 using a measurement signal of the top pressure gauge 171a and a measurement signal of the bottom pressure gauge 171b. The sample 10 is disposed at a connection portion between the first chamber 110 and the second chamber 120, the measurement gas is delivered to the second chamber 120 after permeating the sample 10, and the conductance adjusting part 150 provides at least two different conductances.

The top pressure gauge 171a may measure a pressure of the second chamber 120 according to a conductance of the conductance adjusting part 150. The bottom pressure gauge may measure a pressure of the third chamber 130 according to the pressure of the conductance adjusting part 150.

According to the above-described gas permeability measurement method described, a gas permeability may be precisely calculated by eliminating a parasitic conductance.

Although the present disclosure and its advantages have been described in detail, it should be understood that various changes, substitutions and alterations can be made herein without departing from the spirit and scope of the disclosure as defined by the following claims.

What is claimed is:

1. A gas permeability measurement apparatus comprising:
a first chamber filled with a measurement gas and maintained at a constant pressure;
a second chamber connected in series to the first chamber, and a third chamber connected in series to the second chamber;
a separating plate having a through-hole and separating the second chamber and the third chamber from each other;
a conductance adjusting part disposed at a connection portion between the second chamber and the third chamber to adjust a conductance passing through the through-hole of the separating plate;
a vacuum pump connected to the third chamber to exhaust the third chamber; and
a differential pressure gauge measuring a differential pressure between the second chamber and the third chamber,
wherein a sample is disposed at a connection portion between the first chamber and the second chamber,
the measurement gas is delivered to the second chamber after permeating the sample, and
the conductance adjusting part sequentially provides at least two different conductances.

2. The gas permeability measurement apparatus as set forth in claim 1, further comprising:
a pressure gauge connected to the first chamber;
an auxiliary vacuum pump connected to the first chamber;
a first valve disposed between the first chamber and the auxiliary vacuum pump to exhaust the first chamber;
a gas container storing the measurement gas; and
a second valve disposed between the gas container and the first chamber to deliver the measurement gas stored in the gas container to the first chamber.

3. The gas permeability measurement apparatus as set forth in claim 1, wherein the conductance adjusting part comprises:
a rotation plate with orifices having different radiuses disposed on a circumference having a constant radius from a central axis;
a rotation shaft fixing the rotation plate to the separating plate and providing a rotational motion of the rotation plate;
an auxiliary rotation plate combined with sawteeth formed on an outer edge surface of the rotation plate to provide rotational force; and
an auxiliary rotation shaft providing the rotational force to the auxiliary rotation plate,
wherein the auxiliary rotation shaft rotates while being fixed to the second chamber.

4. A gas permeability measurement apparatus comprising:
a first chamber filled with a measurement gas and maintained at a constant pressure;
a second chamber connected in series to the first chamber, and a third chamber connected in series to the second chamber;
a separating plate having a through-hole and separating the second chamber and the third chamber from each other;
a conductance adjusting part disposed at a connection portion between the second chamber and the third chamber to adjust a conductance passing through the through-hole of the separating plate;
a vacuum pump connected to the third chamber to exhaust the third chamber;
a top pressure gauge measuring a pressure of the second chamber;
a bottom pressure gauge measuring a pressure a pressure of the third chamber; and
a processing part calculating a gas permeability of a sample using a measurement signal of the top pressure gauge and a measurement signal of the bottom pressure gauge,
wherein the sample is disposed at a connection portion between the first chamber and the second chamber,
the measurement gas is delivered to the second chamber after permeating the sample, and
the conductance adjusting part provides at least two different conductances.

5. A gas permeability measurement method comprising:
loading a sample between a first chamber and a second chamber connected in series to each other;
exhausting the first chamber, the second chamber, and a third chamber;
filling the first chamber with a measurement gas to be maintained at a fixed pressure;
delivering the measurement gas filling the first chamber to the second chamber after permeating the sample;
delivering the measurement gas delivered to the second chamber to the third chamber through a first orifice having a first conductance between the second chamber and the third chamber;
measuring a first differential pressure, generated by the first orifice, between the second chamber and the third chamber;
delivering the measurement gas delivered to the second chamber to the third chamber through a second orifice having a second conductance between the second chamber and the third chamber;
measuring a second differential pressure, generated by the second orifice, between the second chamber and the third chamber; and
calculating a gas permeability of the sample using the first differential pressure, the second differential pressure, the first conductance, and the second conductance.
